(19) United States
(12) Patent Application Publication
(10) Pub. No.: US 2011/0256832 A1
(43) Pub. Date: Oct. 20, 2011

(54) APPARATUS AND METHOD FOR CONTROLLING SMART CARD COMPRISED OF MULTI SENSOR

(75) Inventor: Ji-Man PARK, Daejeon-si (KR)

(73) Assignee: Electronics and Telecommunications Research Institute, Daejeon (KR)

(21) Appl. No.: 13/086,697

(22) Filed: Apr. 14, 2011

(30) Foreign Application Priority Data
Apr. 14, 2010 (KR) 10-2010-0034141

(51) Int. Cl. H04B 7/00

(52) U.S. Cl. 455/41.2

(57) ABSTRACT

Provided are a smart card controlling apparatus for controlling a smart card which includes a multi-sensor, and a method thereof. The smart card controlling apparatus may include an interface unit that is connected to a USB terminal of the smart card which includes a multi-sensor and recognizing the smart card, and a communication module to control communication between the recognized smart card and a card reader based on short-range wireless communication.

### TECHNICAL FIELD

The present invention relates to a smart card controlling apparatus and method that controls communication between a card reader and a smart card which includes a multi-sensor, based on short-range wireless communication.

### BACKGROUND ART

A conventional smart card is a multi-functional combination card that includes functions of a contact-type card and a contactless-type card, and may be applicable to various fields, such as traffic, finance, access restriction, and the like. Recently, the international standard ISO 7816 for the contact-type card adopted a universal serial bus (USB) to strengthen a physical communication function, and the international standard ISO 14443 for the contactless-type card developed a high-speed wireless communication system. Various physical types of the smart card have been developed, such as a smart card in a display, a smart card with a bio-sensor, and the like.

As an example, a single smart card may provide various services selected by a user. Accordingly, there may be a desire for a smart card that includes a plurality of contactless protocols and that enables the user to select a protocol from the included protocols, and an apparatus for controlling the smart card to support the services.

### DISCLOSURE

### Technical Goals

An aspect of the present invention provides a smart card controlling apparatus and method that recognizes a smart card using an interface unit that is connected to a universal serial bus (USB) terminal, and controls communication between the recognized smart card and a card reader using short-range wireless communication.

Technical solutions

According to an aspect of the present invention, there is provided a smart card controlling apparatus for controlling a smart card which includes a multi-sensor, the apparatus including an interface unit being connected to a universal serial bus (USB) terminal of the smart card, and recognizing the smart card, and a communication module to control communication between the recognized smart card and a card reader, using short-range wireless communication.

According to an aspect of the present invention, there is provided a smart card controlling method, the method including recognizing the smart card using an interface unit that is connected to a universal serial bus (USB) terminal, and controlling communication between the recognized smart card and a card reader, using short-range wireless communication.

Additional aspects, features, and/or advantages of the invention will be set forth in part in the description which follows and, in part, will be apparent from the description, or may be learned by practice of the invention.

### EFFECT

Example embodiments of the present invention may include a smart card controlling apparatus and method that recognizes a smart card using an interface unit that is connected to a USB terminal, and controls communication between the recognized smart card and a card reader using short-range wireless communication and thus, may provide various services.

### BRIEF DESCRIPTION OF DRAWINGS

FIG. 1 is a diagram illustrating communication between a smart card controlling apparatus, for controlling a smart card which includes a multi-sensor, the smart card, and a card reader, according to an embodiment of the present invention;

FIG. 2 is a diagram illustrating a smart card and an integrated reader apparatus that includes a smart card controlling apparatus for controlling a smart card which includes a multi-sensor according to an embodiment of the present invention;

FIG. 3 is a diagram illustrating a smart card which includes a multi-sensor according to an embodiment of the present invention; and

FIG. 4 is a diagram illustrating software included in a hardware chip structure of a smart card which includes a multi-sensor according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. Embodiments are described below to explain the present invention by referring to the figures.

Example embodiments may provide a smart card controlling apparatus for controlling a smart card which includes a multi-sensor and a method thereof.

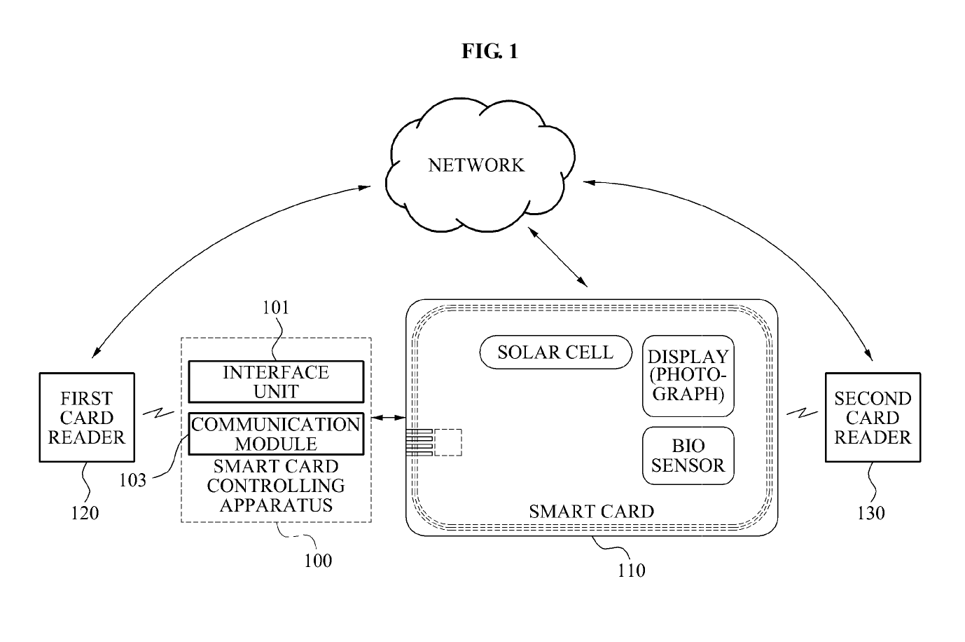

FIG. 1 illustrates communication between a smart card controlling apparatus 100 which includes a multi-sensor, a smart card 110, and a card reader, for example, a first card reader 120 and a second card reader 130, according to an embodiment of the present invention.

Referring to FIG. 1, the smart card controlling apparatus 100 including the multi-sensor may control communication between the smart card 110 and a first card reader 120.

The smart card controlling apparatus 100 may include an interface unit 101 and a communication module 103. The interface unit 101 is connected to a universal serial bus (USB) terminal of the smart card 110, and may recognize the smart card 110. The communication module 103 may control communication between the recognized smart card 110 and the card reader based on short-range wireless communication. In this example, the short-range wireless communication may be communication using one of an ultra-high frequency (UHF) scheme and a Bluetooth system.

For example, when the smart card controlling apparatus 100 includes the communication module 103 supporting the Bluetooth system, the smart card controlling apparatus 100 may communicate with the first card reader 120 based on the Bluetooth system and thus, may provide a service with high reliability and security.

The smart card 110 may be in a form of a dongle, and may further include various sensors for sensing a temperature, a vibration, a humidity, and a sound and thus, may provide various functions.

The smart card 110 may include a USB terminal as a contact-type input output (I/O) interface and may include a radio frequency (RF) tag as a contactless-type I/O interface. The smart card 110 may communicate with the first card reader 120, for example, a USB smart card terminal, through a connection with the smart card controlling apparatus 100 using the USB, and may communicate with the second card reader 130 using the RF tag.

The smart card 110 may include at least one of a solar cell, a display, and a bio-sensor (a fingerprint sensor), and may perform a multi-function.

The smart card controlling apparatus 100 including the multi-sensor may be connected to the USB terminal of the smart card 110 and may control communication with the first card reader 120 and thus, may support a contactless scheme in a contact scheme.

The card reader may include the first card reader 120 corresponding to a UHF reader and the second card reader 130 corresponding to a reader system. In this example, the first card reader 120 may communicate with the smart card 110 using the smart card controlling apparatus 100, and the second card reader 130 may directly perform wireless communication with the smart card 110.

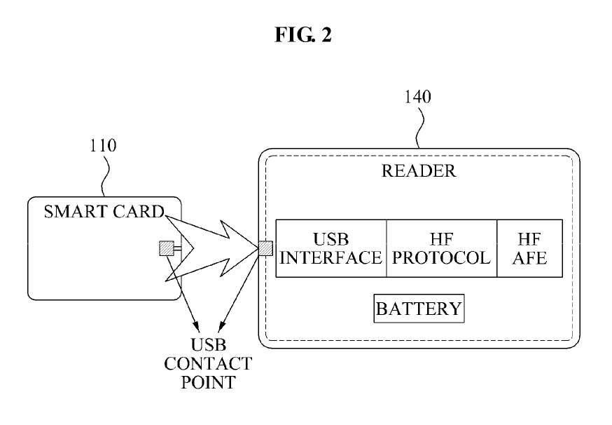

FIG. 2 illustrates a smart card and an integrated reader apparatus 140 that includes a smart card controlling apparatus for controlling a smart card which includes a multi-sensor according to an embodiment of the present invention.

Referring to FIG. 2, the integrated reader apparatus 140 may be connected to a USB terminal of the smart card 110, and may communicate with the smart card 110.

The integrated reader apparatus 140 may match an internal USB contact point (D+, D−, VDD, GND) with a USB contact point of the smart card 110, to perform short-range communication.

To embody a portable size, the integrated reader apparatus 140 may include a physically minimized configuration for a battery and a reader, and may control the reader using the smart card 110.

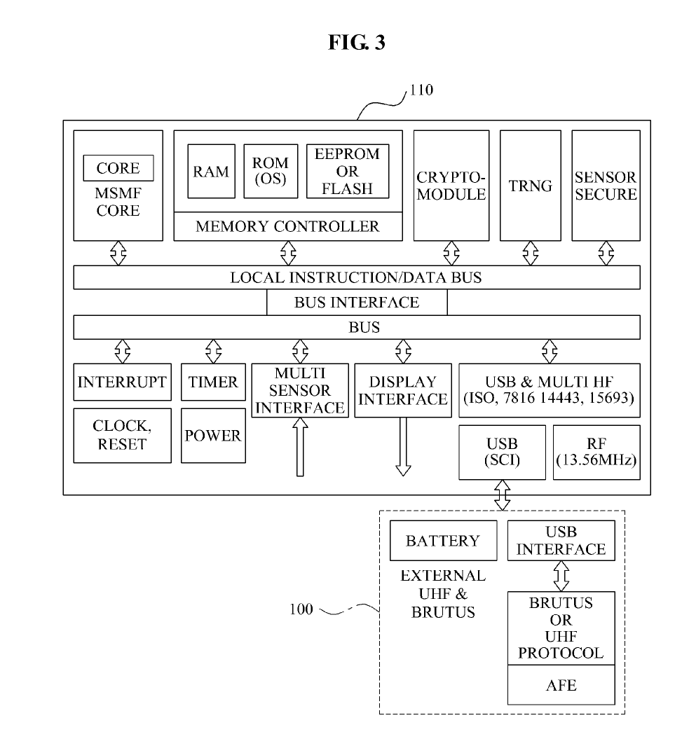

FIG. 3 illustrates a smart card which includes a multi-sensor according to an embodiment of the present invention.

Referring to FIG. 3, the smart card 110 including the multi-sensor may communicate with the smart card controlling apparatus 100 using a USB contact point. In this example, the smart card 110 may have a hardware chip structure, which includes a CPU that is a multiple sensor and multiple function (MSMF) core performing general controlling, a memory controller storing data and operating a card operation system, such as a random access memory (RAM), a read-only memory (ROM), a Flash, and an electrically erasable programmable read-only memory (EEPROM), and parts that are associated with security of the smart card 110 and connected to a data bus, such as a crypto-module, a true random number generator (TRNG), a security sensor. Here, each configuration is connected to a corresponding functional module through a bus interface. The smart card 110 may further include an interrupter, a timer, a multi-sensor, a display, a USB, a multi-HF, and the like, which are connected to the bus.

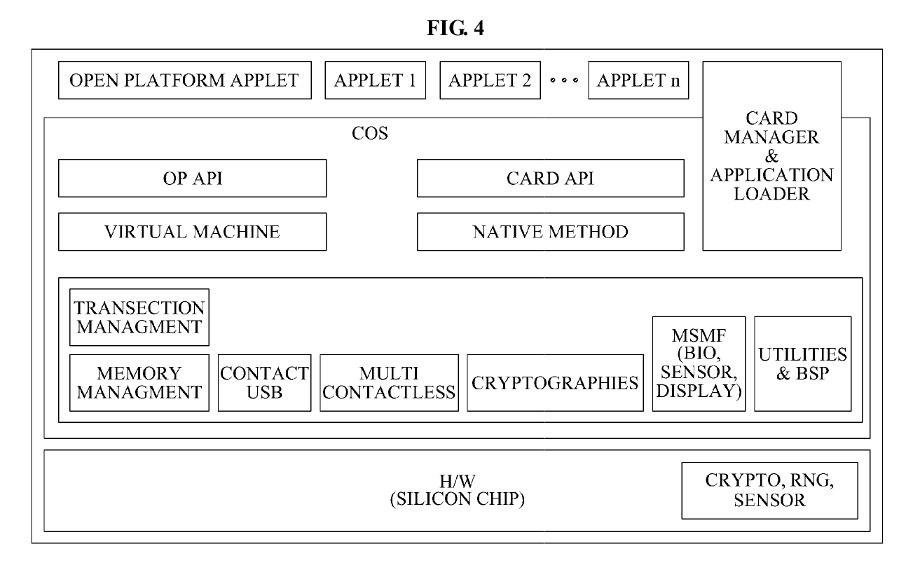

FIG. 4 illustrates software included in a hardware chip structure of a smart card which includes a multi-sensor according to an embodiment of the present invention.

Referring to FIG. 4, the smart card which includes the multi-sensor may have a software structure that is classified as a chip operating system (COS) and an applet. The COS may be included in a flash memory, and may be designed to add a function to perform a multi-function. The applet may be in an open platform and thus may enable a user to selectively contain or delete a service application.

The smart card may further include a COS structure to perform a multi-contactless function, a high-speed sensor, and a display function. The smart card may support a software download function through the Internet. The smart card may utilize various services of electronic information in a home, and may provide the user with a COS for a desired service.

The smart card may include, in the COS, functions of ISO 14443, ISO 15693, and the like in a high frequency (HF) band, and functions of ISO 18000-6, ISO 18000-4, Bluetooth system, and the like in an UHF band and a very UHF (VUHF) band.

According to an embodiment of the present invention, a smart card controlling method that controls a smart card which includes a multi-sensor may include recognizing the smart card through a connection with a USB of the smart card which includes the multi-sensor, and controlling communication between the recognized smart card and a card reader.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus for controlling a smart card which includes a multi-sensor, the apparatus comprising:
an interface unit being connected to a universal serial bus (USB) terminal of the smart card, and recognizing the smart card; and
a communication module to control communication between the recognized smart card and a card reader, using short-range wireless communication.

2. The apparatus of claim 1, wherein the short-range wireless communication corresponds to one of an ultra-high frequency (UHF) scheme and a Bluetooth system.

3. The apparatus of claim 1, wherein the smart card comprises a sensor in a form of a dongle that recognizes at least one of a temperature, a vibration, a humidity, and a sound.

4. The apparatus of claim 1, further comprising:
a battery that supplies power to the interface unit and the communication module.

5. The apparatus of claim 1, wherein, when the card reader is a USB smart card terminal, the communication module controls communication between the smart card and the USB smart card terminal based on a contact scheme.

6. The apparatus of claim 1, wherein, when the card reader is a high frequency (HF) reader system and the smart card approaches the HF reader system, the communication module controls communication between the smart card and the HF reader system based on a contactless scheme.

7. The apparatus of claim 1, wherein the smart card comprises a chip operating system (COS) that is included in a flash memory to perform multiple functions, and an applet that is in an open platform and that supports a function of selectively containing or deleting a service application.

8. A method of controlling a smart card, the method comprising:
recognizing the smart card using an interface unit that is connected to a universal serial bus (USB) terminal; and
controlling communication between the recognized smart card and a card reader, using short-range wireless communication.

9. The method of claim 8, wherein the controlling comprises:
controlling the communication using one of an ultra-high frequency (UHF) scheme and a Bluetooth system as the short-range wireless communication.

10. The method of claim 8, wherein the recognizing comprises:
recognizing at least one of a temperature, a vibration, a humidity, and a sound using a sensor that is included in the smart card and that is in a form of a dongle.

11. The method of claim 8, wherein, when the card reader is a USB smart card terminal, the controlling comprises:
controlling the communication between the smart card and the USB smart card terminal based on a contact scheme.

12. The method of claim 8, wherein, when the card reader is an HF reader system and the smart card approaches the HF reader system, the controlling comprises:
controlling the communication between the smart card and the HF reader system based on a contactless scheme.
